(19) United States
(12) Patent Application Publication
(10) Pub. No.: US 2014/0337013 A1
(43) Pub. Date: Nov. 13, 2014

(54) PROCESSING MESSAGES IN A COMMUNICATION NETWORK

(71) Applicant: Parashar Shah, Bangalore (IN)

(72) Inventor: Parashar Shah, Bangalore (IN)

(73) Assignee: ALCATEL LUCENT, Paris (FR)

(21) Appl. No.: 14/342,030

(22) PCT Filed: Aug. 7, 2012
(86) PCT No.: PCT/EP2012/065423

§ 371 Date: Jul. 1, 2014

(30) Foreign Application Priority Data
Sep. 1, 2011 (IN) 2493/DEL/2011

(51) Int. Cl. G06F 17/28; H04W 4/14

(52) U.S. Cl. CPC G06F 17/28; H04W 4/14
USPC 704/9

(57) ABSTRACT

A method and a system for processing messages in a communication network are described herein. In one implementation, the method includes organizing a plurality of messages in an input queue of a communication terminal (102). The plurality of messages can be associated with a sub-event in an event and received from one or more user devices (104). At least one valid message is identified from the plurality of messages based on a validity status of the messages. Further, the valid message is processed to extract a response information from the valid message, and the response information is compiled to obtain a result of the sub-event in real-time.

### FIELD OF INVENTION

The present subject matter relates to communication networks and, particularly but not exclusively, to processing messages in the communication networks.

### BACKGROUND

The advent of mobile communication has seen a ubiquitous application of mobile technology in various fields, including entertainment. For example, entertainment groups organize various exhibitions and performances, and involve audience to enhance an entertainment quotient of the audience. Usually to involve the audience, various events, such as opinion polls, game shows, and quiz competitions, are conducted by inviting inputs from the audience through mobile devices, such as mobile phones and laptops. During such events, a special number and a keyword is provided to the audience and mobile device users in the audience can provide their inputs, such as answers, polls, and opinions, in the form of text messages, such as short messaging service (SMS) messages, on the special number.

The inputs from the users in the audience are received on a centralized resource and stored. Upon completion of the event, the text messages are processed on the centralized resource and, based on the processing, the results for the event are obtained.

### SUMMARY

This summary is provided to introduce concepts related to processing of messages in a communication network. This summary is not intended to identify essential features of the claimed subject matter nor is it directed to use in determining or limiting the scope of the claimed subject matter.

According to an implementation, a method for processing messages is described herein. In said implementation, the method includes organizing a plurality of messages in an input queue of a communication terminal. The plurality of messages can be associated with a sub-event in an event and received from one or more user devices. At least one valid message is identified from the plurality of messages based on a validity status of the messages. Further, the valid message is processed to extract a response information from the valid message, and the response information is compiled to obtain a result of the sub-event in real-time. Further, according to an implementation, the method can include accessing the result of the sub-event to display the sub-event in real-time.

According to another implementation, a communication terminal for processing messages is described. According to said implementation, the communication terminal includes a processor and a memory coupled to the processor. Further, the memory includes a validation module and an analysis engine. The validation module can be configured to determine a validity status of a plurality of messages received from a user device, the plurality of messages being related to a sub-event. Additionally, the analysis engine can be configured to obtain response information relating to the sub-event from at least one valid message determined from amongst the plurality of messages. The valid message can be determined based on the validity status.

According to yet another implementation, a computer-readable medium having embodied thereon a computer program for executing a method for processing messages is described herein. According to said implementation, the method of the computer-readable medium includes queuing a plurality of messages in an input queue of a communication terminal, the plurality of messages being associated with a sub-event in an event. Further, a validity status of each of the plurality of messages is determined to identify at least one valid message from amongst the plurality of messages. The valid message is analyzed to obtain a response information from the valid message and, further, a response attribute message is generated based on the analysis of the valid message.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network implementation of a communication terminal for processing messages in a communication network, according to an embodiment of the present invention;

FIG. 2 illustrates a method for processing messages in a communication network, in accordance with an embodiment of the present subject matter;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

The present subject matter relates to processing of messages in a communication network.

During events, such as competitions and polls, inputs from users are invited through text messages. Such text messages can be in the form of messages transmitted through short messaging service (SMS). Conventionally, to receive and process such text messages from the users, a dedicated message server is configured. The message server can be configured by connecting a mobile phone array, for example, including a plurality of mobile phones, to a computing device. In said example, the mobile phones in the mobile phone array receive the messages from the users and forward the messages to the computing device which functions as the message server. The computing device, in turn, pushes the messages to a central computing entity, such as a web server, where results are finally processed, compiled, and stored. Upon completion of the event, the central computing entity can be accessed to obtain compiled results of the event.

However, such conventional systems involve latency in operation and incur large amount of operational costs for hosting such events. For example, the results of the events are usually compiled and processed on the message server after the event is closed and the users have ceased to send further messages relating to the event. In said example, since the results are obtained after the closure of the event, a delay occurs in providing access of the results to the users. Further, the large costs are recovered by charging premium rates to the users for the messages being sent from mobile devices, such as mobile phones. Therefore, instead of the organizers of the events, the users end up incurring large costs for participating in such events.

The present subject matter relates to processing of messages in a communication network. According to an implementation, a communication terminal in the communication network is configured to receive a plurality of messages from various participants, analyze the messages, and, based on the analysis, select messages from the plurality of messages for sending to a centralized computing entity. In another implementation of the present subject matter, the communication terminal can analyze the messages, process the messages, and compile and provide the results of the analysis. In one example, the communication terminal is a mobile terminal and includes less computational resources as compared to a conventional message server.

The communication terminal can receive messages from the user devices, for example, mobile terminals. The communication terminal can receive messages from the user devices during an event hosting a sub-event, such as a question posed in a quiz competition, an opinion poll, or a popularity vote. As would be appreciated by a person skilled in the art, the sub-event can be part of another event. Examples of such events include, but are not limited to, quiz competitions, game shows, and such. In an example, the messages can be in the form of messages transmitted through short messaging service (SMS). The messages are received by the communication terminal through service providers, such as mobile operators, of the communication terminal and those of the user devices.

In an implementation, the messages received by the communication terminal can include a keyword and text code. In said example, the text code in the message is in accordance with a predefined syntax based on which the message is processed, and the keyword can be used to identify the messages relating to the sub-event, from other messages received by the communication terminal.

Upon receipt of the message at the communication terminal, the message is placed in an input queue for analysis. Subsequently, the message from the input queue is analyzed in the communication terminal. In an implementation, during the analysis, the message is parsed to determine a validity status of the message, i.e., to identify whether the message is valid or invalid. For example, the validity status of the message can be determined based on the keyword and the syntax of the text code in the message. In addition, the communication terminal can also receive user device information, such as a phone or the subscriber number, associated with the user device. In an implementation, upon the receipt of the message, the user device information can be used to determine whether the message is received from a black-listed user device or whether the message is a part of numerous messages being received from the same user device. Further, in cases when the message is invalid or is received from the black-listed user device, or both, the message can be discarded.

Subsequent to the determination of the validity status of the messages, the messages are analyzed for determining the responses in the messages. In an implementation, valid messages are processed and analyzed based on the keyword or the text code or both, to extract response information from the messages. For example, in case the sub-event is an opinion poll, the validity message is classified into one of the various categories, say “YES”, “NO”, and “MAY BE”, based on the response information in the message. With each message, the total number of messages pertaining to each category is determined. In another case when a popularity poll is conducted to decide a winner among many candidates at a show, the text code can include a candidate ID of the participant for whom the user has voted. In yet another case of the sub-event being a question, the processing can determine the response of the participant from the message and ascertain whether the response is correct or incorrect.

Further, the results of the analysis at the communication terminal, including response information of the users, are transmitted to a central computing entity for further processing, for example, for compilation of results of the sub-event of the complete event, such as a quiz competition. In an implementation, a response attribute message including a response attribute is generated at the communication terminal for each analyzed message. The response attribute can, in turn, be based on the response information. Subsequently, the same is placed in an output queue for being transmitted further to the central computing entity for processing.

In an implementation, the receiving, and processing and transmission of the messages at the communication terminal are achieved intermittently. This facilitates handling traffic of messages. For example, the receiving, and the processing and transmission of the messages are alternately performed, each of the two being performed for predetermined intervals of time. In another example, the communication terminal is configured to process and transmit the messages when incoming messages are not expected. Such an operation facilitates in handling a large traffic of messages with limited computing capability.

Subsequently, the response attribute messages received from the communication terminal are analyzed, compiled and stored at the central computing entity, based on the response attribute therein, to obtain results of the sub-event. For example, the compilation of the results can include determining the cumulative number of votes for a candidate or the cumulative points scored by a participant based on the response attribute messages. In an implementation, the results can be compiled in the form of a graphical representation, such as a bar graph or a pie chart. In addition, the messages from the communication terminal can be recurrently transmitted to the centralized computing entity after every predetermined interval of time. The messages, when received, can be continually analyzed at the central computing entity and the compiled results can be updated on the centralized computing entity based on the additional response attribute messages received. Furthermore, the compiled information on the centralized computing entity can be tapped in real-time and displayed on a display unit. In an example, the displayed results can be updated as and when the compiled results are updated on the centralized computing entity, for example, after every minute.

Further, it will be understood that the functionalities, as described above, which are distributed between the communication terminal and the centralized computing entity, can be implemented completely on the communication terminal. In such an implementation, subsequent to the analysis of messages on the communication terminal, the processing of the messages and subsequent compilation of the results can also be achieved on the communication terminal. In said implementation, the communication terminal can be accessed to obtain the final compiled results, for example, after every update of the compiled results.

According to the foregoing description, the present subject matter for processing messages can be economically implemented on a communication terminal for organizing a communication-based event, such as a quiz competition, at a small scale, the event having various sub-events, which can include a question in a quiz competition or an opinion poll. At the same time, such processing can be scaled for implementation at a larger scale without incurring additional cost. In addition, the users transmit messages to the communication terminal, such as a mobile phone, and therefore, the users are either charged nominally or in certain cases, not charged entirely, for the messages. Further, the processing of the messages and the subsequent compilation is done in real time, for example, after every new message is processed, and hence, the final results of the sub-events of the main event can be presented to the participating users in real time.

The manner in which the systems and methods for processing messages in a communication network are implemented shall be explained in details with respect to the figures. While aspects of described systems and methods for processing messages in a communication network can be implemented in any number of different computing systems, environments, and/or configurations, the embodiments are described in the context of the following exemplary system(s).

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

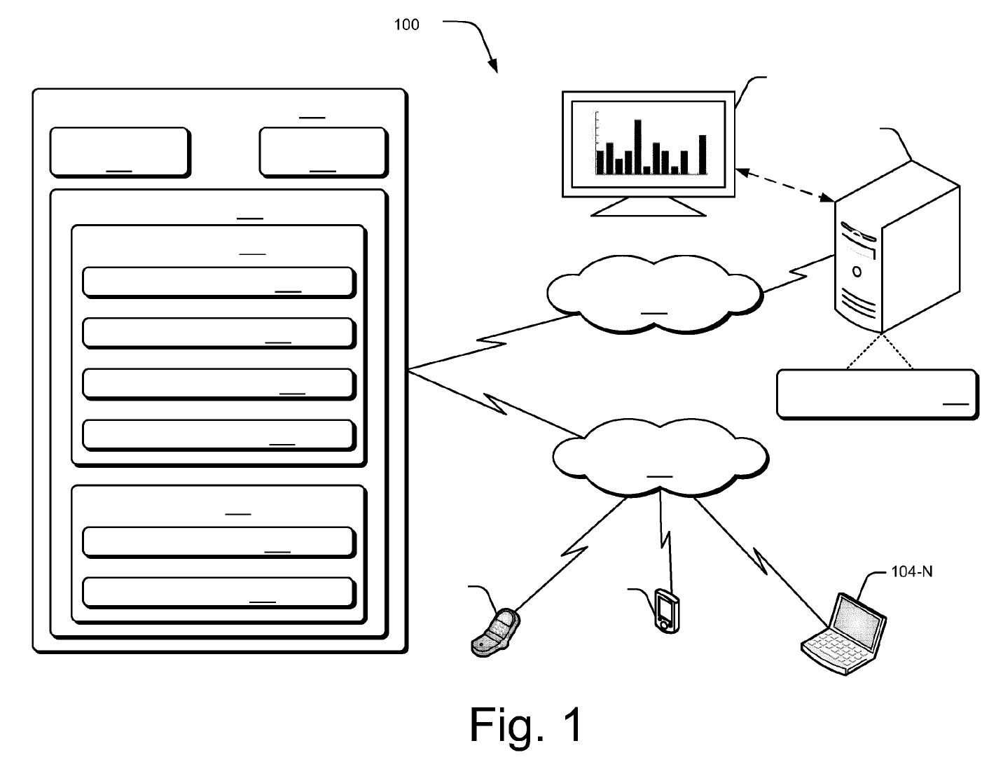

FIG. 1 illustrates network environment 100 implementing a communication terminal 102 for processing messages, in accordance with an embodiment of the present subject matter. Further, the communication terminal 102 is connected to and interacts with a plurality of user devices 104-1, 104-2 . . . 104-N, collectively referred to as the user devices 104 and individually referred to as a user device 104. The communication terminal 102 can include wireless handheld devices, such as mobile phones, personal digital assistant (PDA), smart phones or dash top mobiles. The user devices 104, on the other hand, can include, without limitation, desktop computers, hand-held devices, laptops or other portable computers, network computers, mobile phones, multi-media enabled phones, and smart phones.

The communication terminal 102 and the user devices 104 can communicate with each other over a communication network 106. The communication network 106 may be a wireless or a wired network, or a combination thereof. The communication network 106 can be a collection of individual networks, interconnected with each other and functioning as a single large network (e.g., the internet or an intranet). Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), and Integrated Services Digital Network (ISDN). Depending on the technology, the communication network 106 includes various network entities, such as gateways, routers; however, such details have been omitted for the sake of brevity. Although the description herein is with reference to certain networks, the systems and methods may be implemented in other networks and devices, albeit with a few variations, as will be understood by a person skilled in the art.

Further, according to an embodiment, the communication terminal 102 can be connected to a central computing entity 108 over an auxiliary network 110. The central computing entity 108 may be implemented on any of a variety of conventional computing devices, including, for example, servers, a desktop PC, a notebook or portable computer, a workstation, a mainframe computer, a mobile computing device, an entertainment device, and an internet appliance. In an example, the central computing entity 108 can be implemented as a web server or a cloud-based application server.

The auxiliary network 110 may be a wireless network, wired network or a combination thereof. The auxiliary network 110 can be implemented as one of the different types of networks, such as intranet, local area network (LAN), wide area network (WAN), the internet, and such. The auxiliary network 110 may either be a dedicated network or a shared network, which represents an association of the different types of networks that use a variety of protocols, for example, Hypertext Transfer Protocol (HTTP), Transmission Control Protocol/Internet Protocol (TCP/IP), and Wireless Application Protocol (WAP), to communicate with each other. In one example, the communication terminal 102 can use General Packet Radio Service (GPRS) or Bluetooth for communicating with the central computing entity 108 over the auxiliary network 110. Further, the auxiliary network 110 may include a variety of network devices, including routers, bridges, servers, computing devices, storage devices. In another implementation, the auxiliary network 110 is similar to the communication network 106.

In an implementation, the communication terminal 102 includes processor(s) 112 coupled to a memory 114. The communication terminal 102 further includes interface(s) 116, for example, to facilitate communication with the central computing entity 108. The interface(s) 116 may include a variety of software and hardware interfaces, for example, interfaces for peripheral device(s), such as a keyboard, a mouse, an external memory, and a printer. Further, the interface(s) 116 enables the communication terminal 102 to communicate with other devices, such as web servers and external repositories. The interface(s) 116 can also facilitate multiple communications within a wide variety of networks and protocol types, including wired networks, for example LAN, cable, etc., and wireless networks, such as WLAN, cellular, or satellite. For the purpose, the interface(s) 116 may include one or more ports.

The processor(s) 112 may be implemented as one or more microprocessors, microcomputers, microcontrollers, digital signal processors, central processing units, state machines, logic circuitries, and/or any devices that manipulate signals based on operational instructions. Among other capabilities, the processor(s) 112 are configured to fetch and execute computer-readable instructions stored in the memory 114.

The memory 114 can include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. Further, the memory 114 includes module(s) 118 and data 120.

The module(s) 118 include, for example, a validation module 122, an analysis engine 124, a generation module 126, and other module(s) 128. The other module(s) 128 may include programs or coded instructions that supplement applications or functions performed by the communication terminal 102.

The data 120 includes validation data 130 and other data 132. The other data 132, amongst other things, may serve as a repository for storing data that is processed, received, or generated as a result of the execution of one or more modules in the module(s) 118. Although the data 120 is shown internal to the communication terminal 102, it may be understood that the data 120 can reside in an external repository (not shown in the figure), which is coupled to the communication terminal 102. The communication terminal 102 may communicate with the external repository through the interface(s) 116 to obtain information from the data 120.

In operation, the communication terminal 102 is configured to process messages related to a sub-event, such as a question or an opinion poll, being conducted over the communication network 106. The sub-event can be part of an event, such as a quiz competition in which a plurality of questions can be posed to the participants, or a game show. The communication terminal 102 can receive messages from the user devices 104. Such messages can be related to the sub-event being conducted and can include a response of a participant in the sub-event. For example, in case of the event being a quiz competition, the messages can include an answer in response to a question posed as a sub-event, whereas, in case of an opinion poll, the message can include a choice or a vote cast by the user. In an example, each message sent from the user devices 104 to the communication terminal 102 can include a keyword or a text code or both, which are pertinent to the sub-event and the response with reference to the sub-event. In said example, the keyword can be used to identify the event and the sub-event and the text code can be used to identify the response of the user. Further, in an implementation, the messages received from the user device 104 are in the form of a short messaging service (SMS) messages.

In an implementation, the messages received from the user devices 104 are placed in an input queue for processing. Further, the validation module 122 obtains the messages from the input queue and analyzes the messages to determine a validity status of each of the messages and to further categorize the messages into valid or invalid messages based on the validity status. In implementation, the validation module 122 parses the messages and determines the validity status of a message, i.e., to identify whether the message is valid or invalid, based on the either the keyword or the text code in the message, or based on both. In one example, the validation module 122 can identify the validity of the message by identifying the event and the sub-event based on the keyword included in the message by comparing the keyword to a predetermined set of keywords. Further, the validation module 122 can also determine a syntax of the text code and ascertain whether the text code is in a predefined syntax, to determine the validity status of the messages. The predetermined sets of keywords and the predefined syntax for the text codes can be stored in the validation data 130.

In addition, the validation module 122 can obtain user device information for each of the user devices 104 communicating with the communication terminal 102 to determine the validity of the messages. In an example, the user device information can include the International Mobile Equipment Identity (IMEI) number, the International Mobile Subscriber Identity (IMSI), and phone number associated with the user device 104. Based on the user device information, the validation module 122 can determine whether the messages are recurrently received from the same user device 104, in which case the user device 104 can be black-listed, and the user device information can be tagged as black-listed and stored in the validation data 130. Additionally, based on the user device information, the validation module 122 can also determine whether the message is received from a black-listed user device. In case, the message is received from the black-listed user device, the message is discarded. In one example, to ensure that all the messages in the input queue are analyzed, the validation module 122 handles the messages from the input queue based on first-in-first-out (FIFO) scheme.

Further, in an implementation, subsequent to the determination of the validity status of the messages, the valid messages are processed to analyze the responses in the valid messages. In an example, the analysis engine 124, based on the keyword or the text code or both, can extract response information from the messages and determine the response for the sub-event from the user. The response information can be understood as information, such as a vote or an answer to a question included in the response from the user. In one example, when the sub-event is a question posed in a quiz contest, the analysis engine 124 can determine the answer provided by the user for the question posed during the quiz contest. In another example, in case the sub-event is a popularity poll to adjudicate a winner from amongst a plurality of candidates, then the analysis engine 124 can determine the candidate for whom the user has voted for in the message. In yet another case in which the sub-event is an opinion poll, the analysis engine 124 can determine and classify the message into one of the various categories for the poll, say “YES”, “NO”, and “MAYBE”. In addition, the analysis engine 124 can determine a count of the responses for each sub-event based on the keyword or the text code.

In an implementation, subsequent to the analysis of the responses in the messages by the analysis engine 124, the responses provided by the users are placed in an output queue of the communication terminal 102 and transmitted to the central computing entity 108. In one implementation, the response in each valid message from the user is transmitted to the central computing entity 108 by the generation module 126 in the form of a response attribute. The generation module 126 can generate a response attribute message for each valid message and include the response attribute. The response attribute can be, in turn, based on the keyword or the text code or both in the valid message. Hence, the response attribute message and the response attribute, therein, are based on a content of the valid message.

In an example, the response attribute message can be in the form of an HTTP post message and can be transmitted to the central computing entity 108 over an HTTP-based protocol over the auxiliary network 110. Further, in an example, the response attribute can be included in the response attribute message in the form of a key-value pair. The key may be indicative of the sub-event or a candidate who is a part of the sub-event, and the value can be indicative of the cumulative number of votes for that candidate, in case the sub-event is an opinion poll or a popularity poll.

In addition, the communication terminal 102 is configured to send an acknowledgement message to the user devices 104 after the message is discarded and also after the response attribute message for a valid message is communicated to the central computing entity 108. In an example, the other module(s) 128 can be configured to send the acknowledgement messages to the user devices 104.

According to an implementation, the processing of the messages at the communication terminal 102 is achieved intermittently. In an example, operations of receiving the messages at the communication terminal 102 and of processing and transmitting the messages are alternately performed. Accordingly, the communication terminal 102 receives the messages from the user devices 104 and places the messages in the input queue for a first predetermined interval of time and subsequently the receipt of the messages is suspended for a second predetermined interval of time. During the second predetermined interval, the validation module 122 and the analysis engine 124 process the messages and the generation module 126 prepares to transmit the messages. Further, the transmission of the messages from the communication terminal 102 is also achieved during the second predetermined interval. As a result of such an operation, the communication terminal 102 can handle large amount of message traffic with less computational resources.

In an implementation, the central computing entity 108 can include an aggregation module 134 configured to receive the response attribute messages from the communication terminal 102 and compile the information in the response attribute messages to obtain a result of the sub-event. In said implementation, the aggregation module 134 can determine the information regarding the response by parsing and analyzing the response attribute messages, based on the response attributes. In addition, the aggregation module 134 can compile the results from the response attribute messages in the form of a graphical representation, such as a pie chart or a bar graph.

Furthermore, with the analysis of each response attribute message, the aggregation module 134 updates the result of the sub-event in the central computing entity 108. The central computing entity 108 can be accessed to obtain the result of the sub-event, compiled thereon. In an example, the central computing entity 108 is connected to a display unit 136 to display the results of the sub-event in real time, i.e., with each update by the aggregation module 134 in the central computing entity, the results on the display unit 136 are also updated. In one example, the display unit 136 accesses the central computing entity 108 after every minute to obtain the updated results of the sub-event and those of the event.

With the implementation of the communication terminal 102 for processing the messages, the infrastructure cost and operational cost for processing the messages reduces. In addition, the communication terminal 102 is configured for processing messages and handling large amounts of message traffic with less computational resources. Further, in case the communication terminal 102 is a mobile phone, the cost of communicating with the communication terminal for the participants is also reduced. Additionally, the results of the sub-event can be obtained in real time, with every update in the results being available for access.

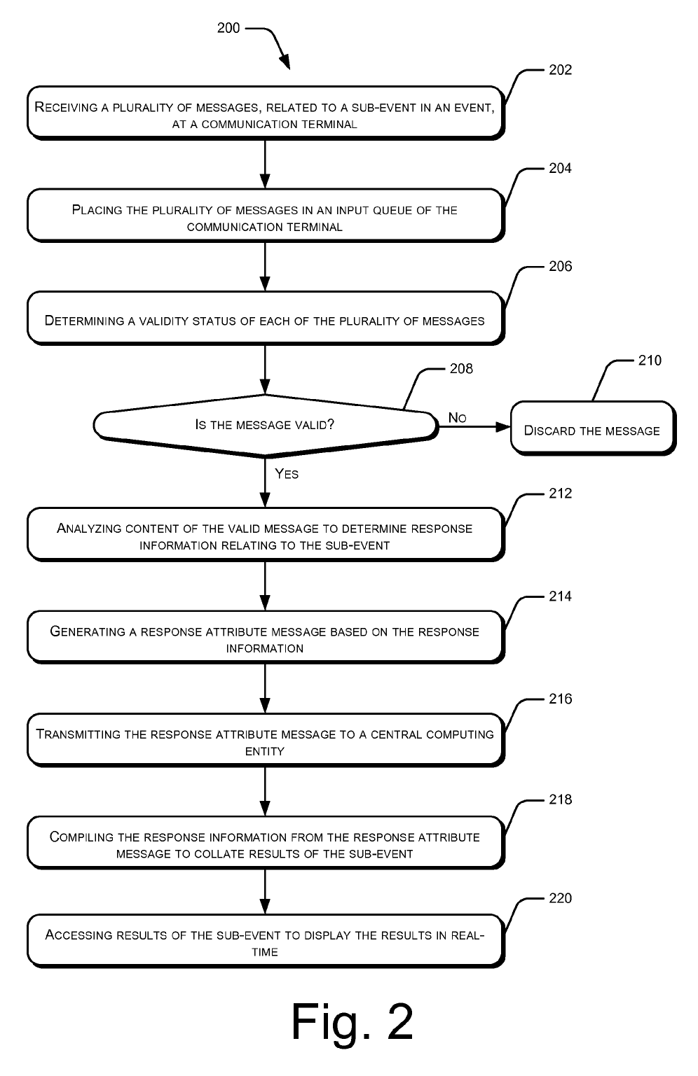

FIG. 2 illustrates a method 200 for processing messages in a communication network, according to an embodiment of the present subject matter. The order in which the method 200 is described is not intended to be construed as a limitation, and any number of the described method blocks can be combined in any order to implement the method 200, or alternative methods. Additionally, individual blocks may be deleted from the method without departing from the spirit and scope of the subject matter described herein. Furthermore, the methods can be implemented in any suitable hardware, software, firmware, or combination thereof.

A person skilled in the art will readily recognize that steps of the method can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media such as a magnetic disks and magnetic tapes, hard drives, or optically readable digital data storage media. The embodiments are also intended to cover both, communication network and communication devices configured to perform said steps of the method 200.

Referring to FIG. 2, at block 202, a plurality of messages related to a sub-event in an event is received by, for example, the communication terminal 102. In an example, the messages can be received from one or more user devices 104 in the form of short messaging service (SMS) messages. The sub-event can be, for example, a popularity poll, an opinion poll, or a question posted as part of a quiz competition event, being conducted over the communication network 106. In an implementation, each of the messages includes a keyword and a text code relating to the sub-event and to the response provided by the user.

At block 204, the messages are placed in an input queue, for example, an input queue of the communication terminal 102, for processing the messages. In an implementation, the messages from the input queue are processed in a first-in-first-out (FIFO) order to ensure that all the messages received by the communication terminal 102 are processed. Further, to facilitate the communication terminal 102 in handling message traffic, in one implementation, the plurality of messages are received and queued in the input queue for a first predetermined interval of time. After the first predetermined interval of time elapses, step at block 206 is executed.

At block 206, each message in the input queue is processed to determine a validity status of the message. In one example, the validation module 122 determines the validity status, i.e., to identify whether the message is valid or invalid, based on the keyword or the text code, or on a combination of both. In said example, the validation module 122 determines the sub-event to which the message pertains based on the keywords, and whether the response is in the correct syntax based on the text code in the message. For the purpose of determining the validity status of the message, the validation module 122 can compare the keyword and the text code in the message with the validation data 130.

Additionally, in one implementation, the validation module 122 can determine the validity status of the message based on user device information associated with the user device 104 sending the message. The user device information can include an International Mobile Equipment Identity (IMEI) number, an International Mobile Subscriber Identity (IMSI), and a phone number associated with the user device 104. Based on the user device information, the validation module 122 can determine whether a plurality of responses is obtained from the same user device 104. In such a case, the validation module 122 tags the user device information as black-listed.

Further, at block 208, it is determined whether the message is a valid message or an invalid message. In case, the message is invalid, as determined based on, for example, the keyword or the text code or the user device information (‘No’ path from block 208), the message is discarded at block 210.

On the other hand, if the message is valid (‘Yes’ path from block 208), then the content of the message is analyzed at block 212 to determine the response provided by the user in the message. In an implementation, the analysis engine 124, based on the keyword or the text code or both, can determine response information in the message. For example, the analysis engine 124 can determine the sub-event to which the message pertains based on the keyword, and the choice or answer provided by the user based on the text code. According to said example, in case the sub-event is a question posed as part of a contest, the keyword can pertain to the sub-event and the text code can pertain to the answer provided by the user for the question posed during the contest.

Further, the response information obtained from the valid message is collated and compiled to determine a result of the sub-event.

At block 214, a response attribute message based on the response information in the valid message is generated by, for example, the generation module 126. In an implementation, the response attribute message includes a response attribute which is based on the response information in the message. In one example, the response attribute is in the form of a key-value pair. The key in the key-value pair can indicate the candidate or the question to which the message pertains and the value can indicate, accordingly, the cumulative votes for the candidate or cumulative points for a participant. Further, in an example, the response attribute message is an HTTP post message.

Subsequently, the response attribute message is placed in an output queue of the communication terminal 102 and is transmitted at block 216. In an implementation, the response attribute message is transmitted from the communication terminal 102 to the central computing entity 108. The central computing entity 108 can be a web server or a cloud based application server.

In an implementation, the steps at block 206 to block 216 are performed for a second predetermined interval of time on the communication terminal 102. When the second predetermined interval of time elapses, steps at block 202 and block 204 are repeated for the first predetermined interval of time. Therefore, the operations of receiving and queuing the messages and those of processing and transmitting the messages are alternated for the first predetermined interval and the second predetermined interval, respectively. Such alternating operation facilitates the communication terminal 102 in handling large amount of message traffic with limited computing capabilities.

Further, at block 218, the response information in the response attribute message is compiled to collate a result of the sub-event. In an implementation, the aggregation module 134 compiles the response information from the response attribute message based on the response attribute. For example, the aggregation module 134 can determine the cumulative number of votes for a candidate and the cumulative points scored by the participant based on the response attribute. Further, the result of the sub-event can be compiled in the form of a graphical representation, such as a bar graph or a pie chart.

Further at block 220, the results of the sub-event, compiled in block 218, are accessed for displaying the results to participants of the sub-event. In an example, the results can be accessed by the display unit 136 to display the results of the sub-event in real time.

The method 200 can be iteratively executed and with every update in the compilation of results of the sub-event at block 218, the updated results are accessed by the display unit 136 at block 220 after a predetermined period, for example, after every minute, and provided to the users in real time.

Although the present subject matter is described with the functionalities distributed between the communication terminal 102 and the central computing entity 108, it will be understood that all the functionalities described herein can be performed by the communication terminal 102. In said implementation, the analyzing module 124 can perform the functions of the aggregation module 134 to analyze the response information in the valid messages and compile the results of the sub-event based on the response information. Further, in said implementation, the communication terminal 102 is directly accessed by the display unit 136 to retrieve the compiled results and to display the results to participants and viewers of the sub-event.

Further, although implementations for processing messages in a communication network have been described in language specific to structural features and/or methods, it is to be understood that the appended claims are not necessarily limited to the specific features or methods described. Rather, the specific features and methods are disclosed as implementations for processing messages in a communication network.

1. A method for processing a plurality of messages in a communication network, the method comprising:
organizing the plurality of messages, received from at least one user device, in an input queue of a communication terminal, wherein the plurality of messages are associated with a sub-event in an event;
identifying at least one valid message from the plurality of messages based on a validity status of each of the plurality of messages;
processing the valid message to extract a response information from the valid message; and
compiling the response information to obtain a result of the sub-event in real-time.

2. The method as claimed in claim 1, wherein the identifying comprises analyzing the plurality of messages based on at least one of user device information associated with the user device, a keyword in each of the plurality of messages, and a text code in each of the plurality of messages.

3. The method as claimed in claim 1, wherein the processing comprises generating a response attribute message for the valid message, based on a content of the valid message.

4. The method as claimed in claim 3, wherein the response attribute message for the valid message is based on at least one of a keyword and a text code in the valid message.

5. The method as claimed in claim 3, wherein the processing comprises transmitting the response attribute message from the communication terminal to a centralized computing entity for processing.

6. The method a claimed in claim 1, wherein the organizing is performed for a first predetermined interval of time, wherein the identifying and the processing are performed for a second predetermined interval of time after the first predetermined interval of time elapses.

7. The method as claimed in claim 1 further comprising accessing the result of the sub-event to display the result of the sub-event in real-time.

8. A communication terminal for processing messages, the communication terminal comprising:
a processor; and
a memory coupled to the processor, the memory comprising:
a validation module configured to determine a validity status of a plurality of messages received from a user device, wherein the plurality of messages pertain to a sub-event; and
an analysis engine configured to obtain response information relating to the sub-event from at least one valid message determined from amongst the plurality of messages, wherein the valid message is determined based on the validity status.

9. The communication terminal as claimed in claim 8, wherein the validation module is further configured to determine the validity of the plurality of messages based on at least one of a keyword in each of the plurality of messages, a text code in each of the plurality of messages, and user device information of the user device.

10. The communication terminal as claimed in claim 8 further comprising a generation module configured to:
generate a response attribute message the valid message based on the response information in the valid message; and
communicate the response attribute message to a central computing entity for compiling a result of the sub-event.

11. The communication terminal as claimed in claim 8, wherein the analysis engine is further configured to analyze the response information in the valid message to compile a result of the sub-event.

12. A computer-readable medium having embodied thereon a computer program for executing a method for processing messages, the method comprising:
queuing a plurality of messages in an input queue of a communication terminal, wherein the plurality of messages are associated with a sub-event in an event;
determining a validity status of each of the plurality of messages to identify at least one valid message from amongst the plurality of messages;
analyzing the valid message to obtain a response information from the valid message; and
generating a response attribute message based on the analyzing.

13. The computer readable medium as claimed in claim 12, wherein the determining is based on at least one of a keyword in each of the plurality of messages, a text code in each of the plurality of messages, and user device information associated with a user device sending the messages to the communication terminal.

14. The computer readable medium as claimed in claim 12, wherein the generating comprises creating a response attribute based on the response information in the valid message.

15. The computer readable medium as claimed in claim 14, further comprising:
transferring the response attribute message to a central computing entity; and
compiling the response attribute in the response attribute message to determine a result of the sub-event.
